(19) United States
(12) Patent Application Publication
(10) Pub. No.: US 2008/0005449 A1
(43) Pub. Date: Jan. 3, 2008

(54) Generalized flash memory and method thereof

(75) Inventors: Jen-Chieh Lou, Hsinchu (TW); Chih-Jen Hsu, Hsinchu (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsinchu (TW)

(21) Appl. No.: 11/478,677

(22) Filed: Jul. 3, 2006

(51) Int. Cl. G06F 12/00

(52) U.S. Cl. 711/103; 711/202

(57) ABSTRACT

The invention presents a flash memory with a generalized interface for facilitating to develop multi-type flash memories and a method thereof. Meanwhile the generalized flash memory includes a physical memory for storing data; a logical controller connected with the physical memory for providing an identify function of the physical memory and communicating with an external system in an unified format; and a buffer register connected with the logical controller, wherein the logical controller and the buffer register map the physical memory to an entire continuous memory space, thereby facilitating to develop multi-type flash memories.

### FIELD OF THE INVENTION

The present invention relates to a generalized flash memory, and more particularly, to a flash memory with a generalized interface for facilitating to develop multi-type flash memories and a method thereof.

### BACKGROUND OF THE INVENTION

Flash memory devices have many advantages for a large number of applications. These advantages include their non-volatility, speed, ease of erasure and reprogramming, small physical size and related factors. There are no mechanical moving parts and as a result such systems are not subject to failures of the type most often encountered with hard disk storage systems. As a result many portable computer devices, such as laptops, portable digital assistants, portable communication devices, and many other related devices are using flash memory as the primary medium for storage of information.

In practice, there are several kinds of flash memory with different specifications. Usually, new data can be written over previous old data. However, in flash memories, a block needs to be erased before it is rewritten with new data; that is, memory cells are returned to an original state in which data can be written. This operation is called “erase”. An erase operation typically requires much more time than a write operation. Furthermore, since the erase operation is performed in blocks whose size is much larger than what the write operation requires, even a portion requested not to be written to may be erased. In this case, the unnecessarily erased portion needs to be reclaimed through a write operation. In the worst scenario, a request to write (overwrite) data requires one erase operation and write operations to recover the portion erased by the erase operation.

Please refer to FIG. 1. It illustrates a flash memory based system including a flash memory 1, a read-only memory (ROM) 2, a random access memory (RAM) 3, and a processor 4. In combination with program codes typically recorded in the ROM 2, the processor 4 issues a series of read or write commands to read data from and write data to the flash memory 1 or the RAM 3. Write and read operations are performed on the flash memory 1 in accordance with a flash memory management method according to the present invention. The ROM 2 and the RAM 3 store application program codes executed by the processor 4 or related data structures.

Please further refer to FIG. 2. As shown in FIG. 2, the flash memory 1 includes a plurality of data blocks and log blocks corresponding to at least some of the plurality of data blocks. A data block is a block for storing any ordinary data, and a log block is a block provided for recording modified data if a predetermined part of a data block is to be modified. Thus, a plurality of log blocks corresponding to the plurality of data blocks contain modified pages of the corresponding data blocks. Pages stored in the log blocks have priority over the counterparts stored in the corresponding data blocks to be referred to.

When a request of a user to read a predetermined page at a predetermined logical address is issued, the processor 4 refers to a log pointer table recorded in the RAM 3 to check whether a log block corresponding to the predetermined page exists. If a corresponding log block exists, a check is made as to whether the requested page is validly stored in the log block. If the requested page is validly stored in the log block, the page stored in the log block is read. If not, a corresponding page stored in the data block corresponding to the log block is read. The log pointer table refers to a data structure for managing log blocks. The log pointer table contains a logical address of a data block, a physical address of a corresponding log block, and offset values (a logical address of a requested page) of updated pages in the corresponding data block arranged in the same order in which pages in the log block are physically arranged. According to the present invention, the processor 4 scans a log block region to construct the log pointer table in the RAM 3. Referring to FIG. 3, the log pointer table contains entries corresponding to each of the log blocks. Upon receiving a request to read data from or write data to a specific location in the flash memory 1 along with a logical address of a predetermined page, the processor 4 refers to the log pointer table to access a log block or a data block depending on the presence of a corresponding entry.

However, there are many kinds of flash memories provided for a large number of applications, and large memory space and multi functions are introduced into flash memories. When a designer of flash memory would like to design the software or hardware for flash memory, he has to consider the specification supplied in response to different flash memories. According to the prior art, the processor always refers to the log pointer table of RAM 3 to access a log block or a data block of the flash memory 1. When the system of FIG. 1 is initialized, the processor 4 must construct the log pointer table of RAM 3 and the lists of all blocks of the flash memory 1. The log pointer table is constructed by scanning all pages of each block designated to read a logical address stored in a logical block address portion for each page. For multi-type flash memories manufactured by different process, with different types of memory cells and inner managing system, the processor and the RAM should be able to identify different specifications of multi-type flash memories. Thus, the manufacturers of flash memories have to consider the specification and managing system supplied in response to the processor and the RAM.

Therefore, in practice, the prior art should waste more time and source and cost a lot for developing the flash memory. On the other hand, it is difficult to implement. Hence, it needs to provide a generalized flash memory, which provides a generalized interface for managing the flash memory, simplifies the entire structure and the managing process thereof, is capable of achieving the purpose of facilitating to develop multi-type flash memories easily, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a generalized flash memory, which provides a generalized interface for managing the flash memory, simplifies the entire structure and the managing process thereof, is capable of achieving the purpose of facilitating to develop multi-type flash memories easily, and can rectify those drawbacks of the prior art and solve the above problems.

In accordance with an aspect of the present invention, the generalized flash memory includes a physical memory for storing data; a logical controller connected with the physical memory for providing an identify function of the physical memory and communicating with an external system in an unified format; and a buffer register connected with the logical controller, wherein the logical controller and the buffer register map the physical memory to an entire continuous memory space.

Preferably, the physical memory is a Random Access Memory (RAM).

Preferably, the logical controller further includes an access interface for connecting with the external system.

Preferably, the access interface is one selected from a group consisting of a flash memory access interface, a USB port, a COM port and a print port.

Preferably, the logical controller further includes a programmable circuit device for storing specifications of the physical memory.

Preferably, the logical controller further includes a wear leveling module for programming the physical memory evenly.

Preferably, the logical controller further includes an anti-disturbance module for preventing write disturbance and keeping the validity of data in the physical memory.

In accordance with another aspect of the present invention, the generalized flash memory includes a physical memory for storing data; and a logical controller connected with the physical memory and mapping the physical memory to an entire continuous memory space for providing an identify function of the physical memory and communicating with an external system in an unified format.

Preferably, the logical controller further includes an access interface for connecting with the external system.

Preferably, the access interface is one selected from a group consisting of a flash memory access interface, a USB port, a COM port and a print port.

Preferably, the logical controller further includes a programmable circuit device for storing specifications of the physical memory.

Preferably, the logical controller further includes a wear leveling module for programming the physical memory evenly.

Preferably, the logical controller further includes an anti-disturbance module for preventing write disturbance and keeping the validity of data in the physical memory.

It is another object of the present invention to provide a method of a generalized flash memory, which provides a generalized interface for managing the flash memory, simplifies the entire structure and the managing process thereof, is capable of achieving the purpose of facilitating to develop multi-type flash memories easily, and can rectify those drawbacks of the prior art and solve the above problems.

In accordance with an aspect of the present invention, the method of generalized flash memory includes the steps of: a) providing a physical memory for storing data; b) mapping the physical memory to an entire continuous memory space via a logical controller connected with the physical memory for providing an identify function of the physical memory and communicating with an external system in an unified format; c) issuing a request from the external system; and d) executing the request via the logical controller to access the entire continuous memory space of the physical memory.

Preferably, the request is a single operation for the physical memory and free of managing a block-mapping of physical memory.

Preferably, the step d) further comprises step d1) of programming the physical memory evenly by a wear leveling module of the logical controller for keeping the physical memory as an entire continuous memory space.

Preferably, wherein the step d) further includes step d2) of keeping the validity of data in the physical memory via an anti-disturbance module of the logical controller for preventing write disturbance of the physical memory.

Preferably, the step b) further includes step b1) of providing specifications of the physical memory for storage in a programmable circuit device of the logical controller.

Preferably, the physical memory is a Random Access Memory (RAM).

Preferably, the logical controller further includes an access interface for connecting with the external system.

Preferably, the access interface is one selected from a group consisting of a flash memory access interface, a USB port, a COM port and a print port.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates block diagram of a flash memory based system according to the prior art;

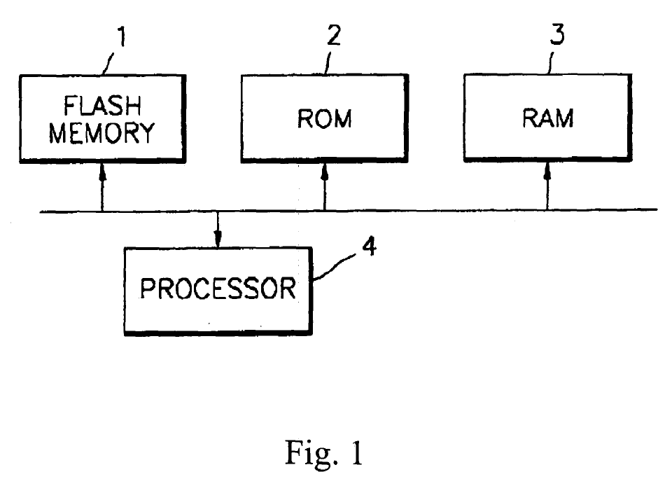

FIG. 2 illustrates a reference diagram for explaining blocks for storing ordinary data provided in the flash memory of FIG. 1 according to the prior art;

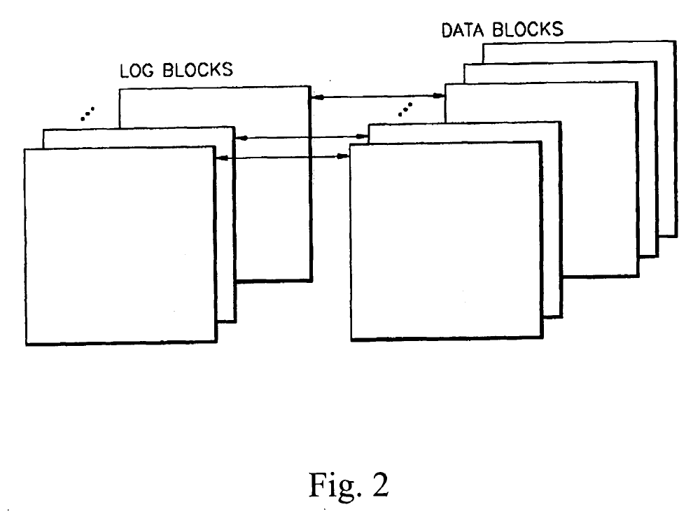

FIG. 3 illustrates a reference diagram for explaining a log pointer table according to the prior art;

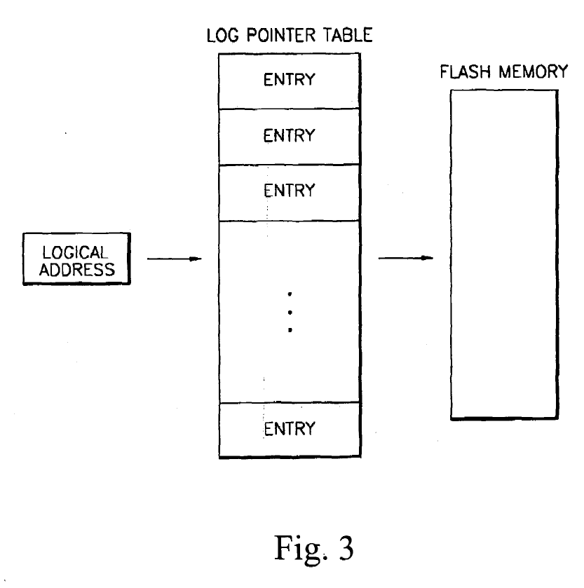

FIG. 4 illustrates a preferred embodiment of a generalized flash memory according to the present invention;

FIG. 5 illustrates a case of issuing a request from an external system to the generalized flash memory of to the present invention;

FIG. 6 illustrates another case of issuing a request from an external system to the generalized flash memory of to the present invention;

FIG. 7 illustrates another preferred embodiment of a generalized flash memory according to the present invention;

FIG. 8 illustrates a preferred method of a generalized flash memory according to the present invention.

### DETAILED DESCRIPTION OF THE PREFERRED EMBODIMENT

The present invention discloses a flash memory with a generalized interface for facilitating to develop multi-type flash memories and a method thereof, and the objects and advantages of the present invention will become more readily apparent to those ordinarily skilled in the art after reviewing the following detailed description. The present invention needs not be limited to the following embodiment.

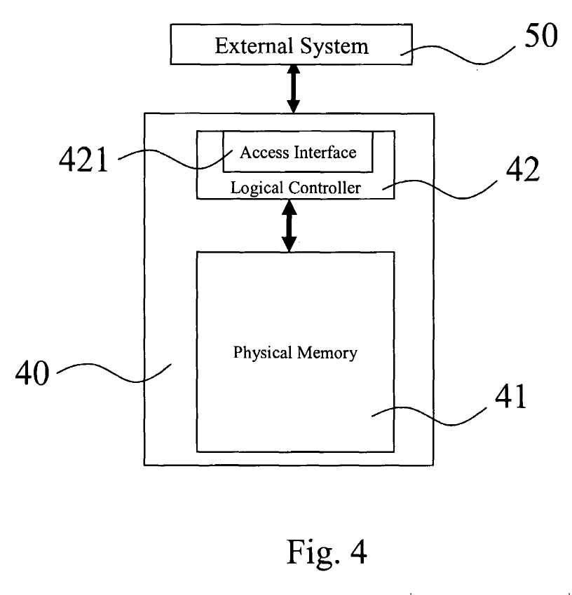

Please refer to FIG. 4. It illustrates a preferred embodiment of a generalized flash memory according to the present invention. As shown in FIG. 4, the generalized flash memory includes a physical memory 41 for storing data; and a logical controller 42 connected with the physical memory 41 and mapping the physical memory 41 to an entire continuous memory space for providing an identify function of the physical memory 41 and communicating with an external system 50 in an unified format.

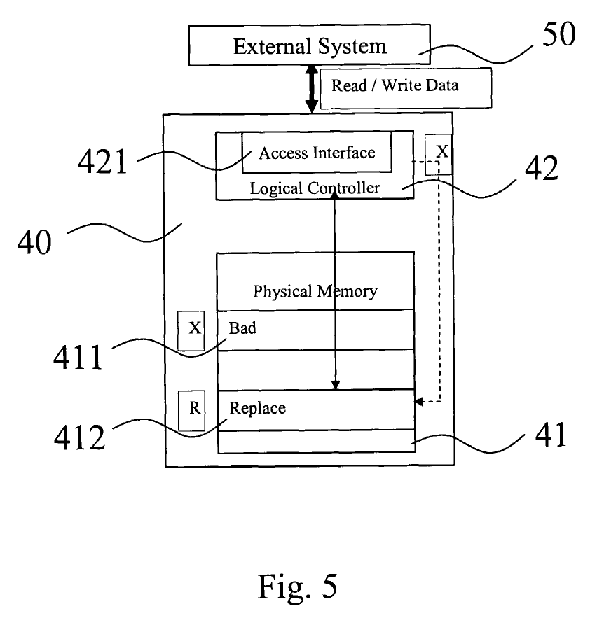

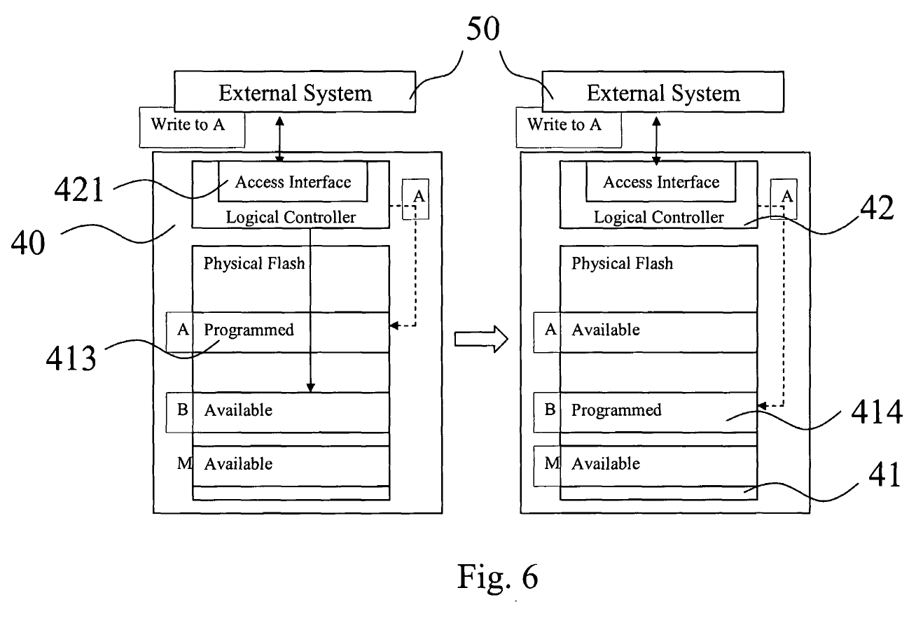

In practice, the logical controller 42 further includes an access interface 421 for connecting with the external system 50, wherein the access interface 421 is one selected from a group consisting of a flash memory access interface, a USB port, a COM port and a print port. In this embodiment, the logical controller 42 could further include a programmable circuit device (not shown) for storing specifications of the physical memory 41 to achieve the purpose of simulating the interface and functions of different flash memories easily. Furthermore, the logical controller further includes a wear leveling module for programming the physical memory evenly or an anti-disturbance module for preventing write disturbance and keeping the validity of data in the physical memory. According to the present invention, the physical memory 41 is mapped to an entire continuous memory space and the user from the external system 50 need not manage any block of the physical memory 41. For example, referring to FIG. 5, the logical controller 42 will manage all blocks of the physical memory 41. When a request of read/write data to a bad block 411 of the physical memory 41 is issued from the external system 50, the logical controller 42 will re-map the bad block 411 to a replace block 412 and then the request of read/write data is executed to the replace block 412, as shown in FIG. 5. In other case, when a request of write data to a programmed block 413 of the physical memory 41 is issued from the external system 50, the logical controller 42 will re-map the programmed block 413 to an available block 414 and then the request of write data is executed to the available block 414, as shown in FIG. 6. In the present invention, the mapping, from the logical blocks to the physical blocks of the physical memory, is managed by the logical controller. The user of the external system 50 won't manage one erase operation and write operations to recover the portion erased by the erase operation for executing a request to write (overwrite) data. For the user of the external system 50, the physical memory is an entire continuous and available memory space

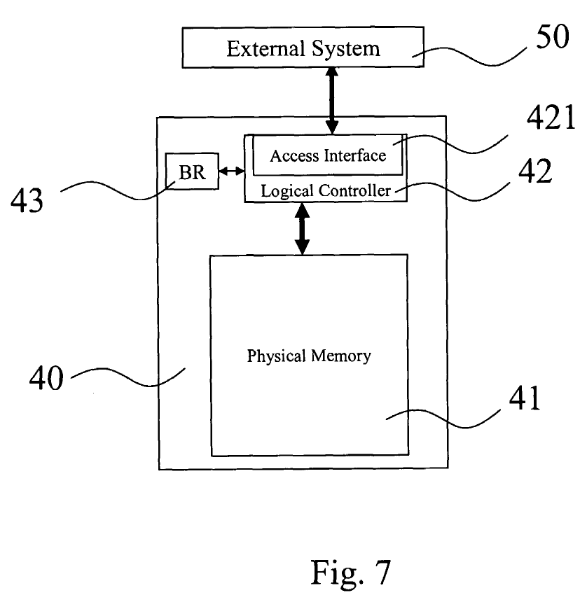

Please refer to FIG. 7. It illustrates a preferred embodiment of a generalized flash memory according to the present invention. As shown in FIG. 7, the generalized flash memory includes a physical memory 41 for storing data; a logical controller 42 connected with the physical memory 41 for providing an identify function of the physical memory 41 and communicating with an external system 50 in an unified format; and a buffer register 43 connected with the logical controller 42, wherein the logical controller 42 and the buffer register 43 map the physical memory to an entire continuous memory space.

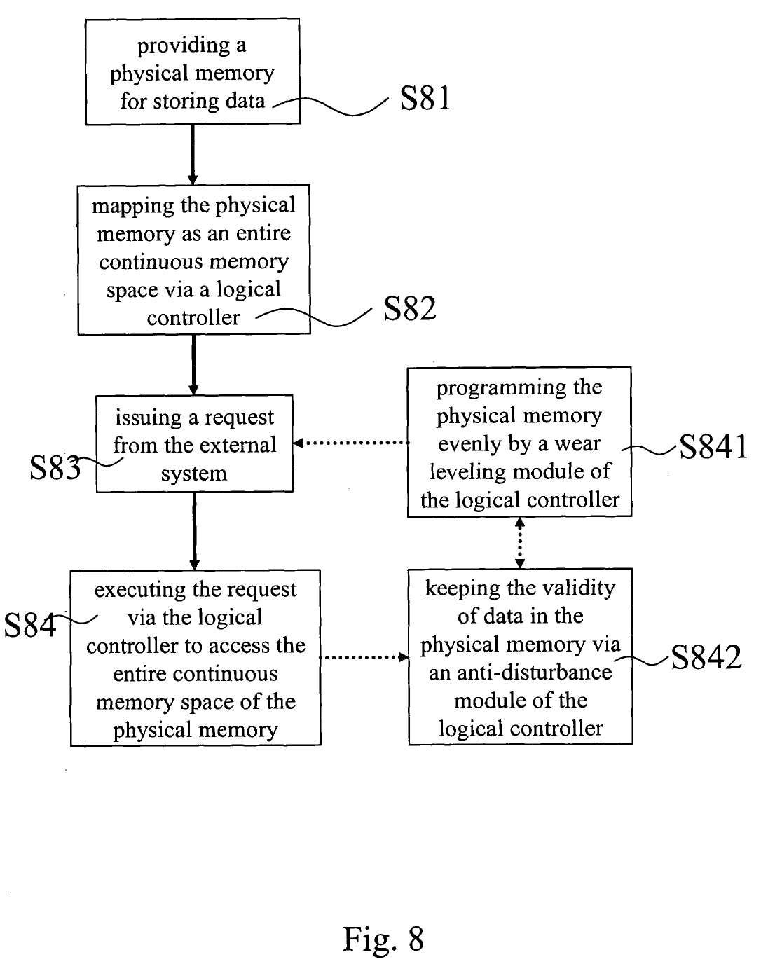

Similarly, the logical controller 42 further includes an access interface 421 for connecting with the external system 50, wherein the access interface 421 is one selected from a group consisting of a flash memory access interface, a USB port, a COM port and a print port. In this embodiment, the logical controller 42 could further include a programmable circuit device (not shown) for storing specifications of the physical memory 41 to achieve the purpose of simulating the interface and functions of different flash memories easily. Furthermore, the logical controller further includes a wear leveling module for programming the physical memory evenly or an anti-disturbance module for preventing write disturbance and keeping the validity of data in the physical memory. According to the above embodiment, the present invention also discloses a method of the generalized flash memory for managing the flash memory and achieving the purpose of facilitating to develop multi-type flash memories easily. Please refer to FIG. 8. It illustrates a preferred method of a generalized flash memory according to the present invention. As shown in FIG. 8, the method of generalized flash memory includes the steps of: a) providing a physical memory for storing data, as in the procedure S81; b) mapping the physical memory to an entire continuous memory space via a logical controller connected with the physical memory for providing an identify function of the physical memory and communicating with an external system in an unified format, as in the procedure S82; c) issuing a request from the external system, as in the procedure S83; and d) executing the request via the logical controller to access the entire continuous memory space of the physical memory, as in the procedure S84.

In practice, the request is a single operation for the physical memory and free of managing a block-mapping of physical memory. Preferably, the step d) further comprises step d1) of programming the physical memory evenly by a wear leveling module of the logical controller for keeping the physical memory as an entire continuous memory space, as in the procedure S841; and step d2) of keeping the validity of data in the physical memory via an anti-disturbance module of the logical controller for preventing write disturbance of the physical memory, as in the procedure S842. The present invention further discloses a logical controller with a programmable circuit device to store specifications of the physical memory for providing an identify function of the physical memory and communicating with the external system in a unified format, thereby facilitating to develop multi-type flash memories. Certainly, the physical memory can be a Random Access Memory (RAM). Moreover, the logical controller further includes an access interface for connecting with the external system; and the access interface can be one selected from a group consisting of a flash memory access interface, a USB port, a COM port and a print port.

In conclusion, the present invention provides a generalized flash memory, which provides a generalized interface for managing the flash memory, simplifies the entire structure and the managing process thereof, is capable of achieving the purpose of mapping the physical memory to an entire continuous memory space, and can rectify those drawbacks of the prior art and solve the above problems. The present invention further discloses a logical controller with a programmable circuit device to store specifications of the physical memory for providing an identify function of the physical memory and communicating with the external system in a unified format, thereby facilitating to develop multi-type flash memories. Meanwhile the prior art fail to disclose that. Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A generalized flash memory comprising:
a physical memory for storing data;
a logical controller connected with said physical memory for providing an identify function of said physical memory and communicating with an external system in an unified format; and
a buffer register connected with said logical controller, wherein said logical controller and said buffer register map said physical memory to an entire continuous memory space.

2. The generalized flash memory according to claim 1, wherein said physical memory is a Random Access Memory (RAM).

3. The generalized flash memory according to claim 1, wherein said logical controller further comprises an access interface for connecting with said external system.

4. The generalized flash memory according to claim 3, wherein said access interface is one selected from a group consisting of a flash memory access interface, a USB port, a COM port and a print port.

5. The generalized flash memory according to claim 1, wherein said logical controller further comprises a programmable circuit device for storing specifications of said physical memory.

6. The generalized flash memory according to claim 1, wherein said logical controller further comprises a wear leveling module for programming said physical memory evenly.

7. The generalized flash memory according to claim 1, wherein said logical controller further comprises an anti-disturbance module for preventing write disturbance and keeping the validity of data in said physical memory.

8. A generalized flash memory comprising:
a physical memory for storing data; and
a logical controller connected with said physical memory and mapping said physical memory to an entire continuous memory space for providing an identify function of said physical memory and communicating with an external system in an unified format.

9. The generalized flash memory according to claim 8, wherein said logical controller further comprises an access interface for connecting with said external system.

10. The generalized flash memory according to claim 9, wherein said access interface is one selected from a group consisting of a flash memory access interface, a USB port, a COM port and a print port.

11. The generalized flash memory according to claim 8, wherein said logical controller further comprises a programmable circuit device for storing specifications of said physical memory.

12. The generalized flash memory according to claim 8, wherein said logical controller further comprises a wear leveling module for programming said physical memory evenly.

13. The generalized flash memory according to claim 8, wherein said logical controller further comprises an anti-disturbance module for preventing write disturbance and keeping the validity of data in said physical memory.

14. A method of generalized flash memory comprising the steps of:
a) providing a physical memory for storing data;
b) mapping said physical memory to an entire continuous memory space via a logical controller connected with said physical memory for providing an identify function of said physical memory and communicating with an external system in an unified format;
c) issuing a request from said external system; and
d) executing said request via said logical controller to access said entire continuous memory space of said physical memory.

15. The method according to claim 14, wherein said request is a single operation for said physical memory and free of managing a block-mapping of physical memory.

16. The method according to claim 14, wherein said step d) further comprises step d1) of programming said physical memory evenly by a wear leveling module of said logical controller for keeping said physical memory as an entire continuous memory space.

17. The method according to claim 14, wherein said step d) further comprises step d2) of keeping the validity of data in said physical memory via an anti-disturbance module of said logical controller for preventing write disturbance of said physical memory.

18. The method according to claim 14, wherein said step b) further comprises step b1) of providing specifications of said physical memory for storage in a programmable circuit device of said logical controller.

19. The method according to claim 14, wherein said physical memory is a Random Access Memory (RAM).

20. The method according to claim 14, wherein said logical controller further comprises an access interface for connecting with said external system.

21. The method according to claim 20, wherein said access interface is one selected from a group consisting of a flash memory access interface, a USB port, a COM port and a print port.
